(19) United States
(12) Patent Application Publication
(10) Pub. No.: US 2026/0025060 A1
(43) Pub. Date: Jan. 22, 2026

(54) ACTIVE RESONANCE MITIGATION METHODS FOR QUASI-TWO-LEVEL-BASED CONVERTERS

(71) Applicant: NUtech Ventures, Inc., Lincoln, NE (US)

(72) Inventor: Jun Wang, Lincoln, NE (US)

(21) Appl. No.: 19/272,842

(22) Filed: Jul. 17, 2025

Related U.S. Application Data
(60) Provisional application No. 63/672,845, filed on Jul. 18, 2024.

(51) Int. Cl. H02M 1/08; H02M 7/42

(52) U.S. Cl. CPC H02M 1/08; H02M 7/42

(57) ABSTRACT

The present disclosure provides systems and method for reducing LC resonance in Quasi-two-level (Q2L) circuits. In an embodiment, a quasi-two-level (Q2L) phase leg circuit is provided, including a first phase arm comprising a plurality of switch devices in a series connection, and a second phase arm comprising a plurality of switch devices in a series connection. The first phase arm and the second phase arm are connected in series between two terminals of a voltage source. A switching terminal is connected to a point located between the first phase arm and the second phase arm. Each switch device of the plurality of switch devices in the first phase arm and the second phase arm includes a main switch with a first on-resistance and an auxiliary switch with a second on-resistance. The second on-resistance is greater than the first on-resistance.

### CLAIM OF PRIORITY

This application claims the benefit of U.S. Provisional Application No. 63/672,845 titled “Active-Resonance Mitigation Methods for Quasi-Two-Level-Based Converters,” filed Jul. 18, 2024, the entire contents of which are incorporated herein by reference.

### BACKGROUND

The U.S. power grid today faces the unprecedented challenge of delivering significantly more electricity due to the rapid proliferation of data centers and the widespread adoption of electric vehicles. To support this growing demand, more advanced high-voltage (HV) transmission and medium-voltage (MV) distribution power converters will be critical in enabling the next-generation energy infrastructure.

However, many of the grid-oriented power devices used in these converters are over 25 years old. Press-pack silicon (Si) Insulated Gate Bipolar Transistor (IGBT) and Integrated Gate-Commutated Thyristor (IGCT) modules—valued for their high current capabilities, reduced susceptibility to partial discharge (PD), and built-in safety features—are constrained by limited voltage ratings (below 6.5 kilovolts (kV)) and low switching frequencies (below 500 Hertz (Hz)). These limitations hinder the development of innovative High-Voltage Direct Current (HVDC) and Medium-Voltage Direct Current (MVDC) converter topologies aimed at achieving higher power density, lower costs, and improved grid resilience.

Silicon carbide (SiC) Metal-Oxide-Semiconductor Field-Effect Transistor (MOSFETs) rated at 10 kV and above have the potential to overcome these barriers. However, they are currently only available in low-current, non-explosion-proof planar-pack modules that do not satisfy the stringent requirements of grid applications. Moreover, existing press-pack packaging techniques are inherently incompatible with fast, low-profile SiC dies due to: (1) substantial stray inductance (Lₛ); (2) nonuniform pressure distribution across multiple small dies; and (3) the absence of noise-immune gate-drive circuitry suitable for high-voltage SiC devices.

In light of these challenges, new technological developments are urgently needed to advance the next generation of grid power conversion systems.

### SUMMARY

The present disclosure provides methods and devices for reducing LC resonance in Quasi-two-level (Q2L) circuits.

According to an embodiment, a quasi-two-level (Q2L) phase leg circuit is provided. The Q2L phase leg circuit includes a first phase arm comprising a plurality of switch devices in a series connection; and a second phase arm comprising a plurality of switch devices in a series connection. The first phase arm and the second phase arm are connected in series between two terminals of a voltage source. A switching terminal (or AC terminal) is connected to a point located between the first phase arm and the second phase arm. Each switch device of the plurality of switch devices in the first phase arm and each switch device of the plurality of switch devices in the second phase arm comprises: a main switch with a first on-resistance; and an auxiliary switch with a second on-resistance, wherein the second on-resistance is greater than the first on-resistance.

According to an embodiment, each switch device of the plurality of switch devices in the first phase arm and each switch device of the plurality of switch devices in the second phase arm comprises a capacitor, wherein in the respective switch device of the plurality of switch devices in the first phase arm and the second phase arm, the corresponding capacitor and auxiliary switch are connected in series, and the corresponding main switch is connected in parallel.

According to an embodiment, the plurality of switch devices of at least one of the first phase arm and the second phase arm includes n switch devices, wherein n is an integer greater than one, wherein the n switch devices in the respective phase arm are configured to turn on at different timings, resulting in a switch transient that comprises n+1 voltage staircases.

According to an embodiment, the plurality of switch devices of the first phase arm or the second phase arm comprise one or more half-bridge submodules (HBSMs).

According to an embodiment, the plurality of switch devices of the first phase arm or the second phase arm comprise at least one of Insulated Gate Bipolar Transistor (IGBT), Integrated Gate-Commutated Thyristor (IGCT), Metal-Oxide-Semiconductor Field-Effect Transistor (MOSFET), or Junction Field-Effect Transistor (JFET).

According to an embodiment, the plurality of switch devices of the first phase arm or the second phase arm are made of silicon or wide bandgap (WBG) materials (e.g., SiC, GaN, AlGaN, etc.).

According to an embodiment, the auxiliary switches in the plurality of switch devices of the first phase arm or the second phase arm are unidirectional.

According to an embodiment, one or more auxiliary switches in the plurality of switch devices of the first phase arm or the second phase arm operate in a partially-on state during a switch transient.

According to an embodiment, the one or more auxiliary switches are controlled by an on-state gate driving voltage for the one or more auxiliary switches, and wherein the on-state gate driving voltage is determined based on output characteristics of the Q2L phase leg circuit.

According to an embodiment, the on-state gate of the one or more auxiliary switches are actively controlled with variable voltage values and timings for different auxiliary switches.

According to an embodiment, the auxiliary switches in the plurality of switch devices of the first phase arm or the second phase arm are bidirectional.

According to an embodiment, each auxiliary switch of the auxiliary switches in the plurality of switch devices of the first phase arm or the second phase arm comprises a pair of metal-oxide-semiconductor field-effect transistors (MOSFETs) in a back-to-back configuration.

According to an embodiment, each auxiliary switch of the auxiliary switches in the plurality of switch devices of the first phase arm or the second phase arm comprises a junction field-effect transistor (JFET) and a MOSFET. The JFET is connected in anti-series with the MOSFET.

According to an embodiment, each auxiliary switch of the auxiliary switches in the plurality of switch devices of the first phase arm or the second phase arm operates in four distinct states. The four states include a first state when the main switch is on, the JFET in the auxiliary switch is on, and the MOSFET in the auxiliary switch is off, a second state when the main switch is off, the JFET in the auxiliary switch is on, and the MOSFET in the auxiliary switch is on, thereby a capacitor is inserted into a circuit path comprising the auxiliary switch, a third state when the main switch is off, the JFET in the auxiliary switch is on, and the MOSFET in the auxiliary switch is off, where the capacitor in the circuit path comprising the auxiliary switch is pre-charged, and a fourth state when the main switch is off, the JFET in the auxiliary switch is off, and the MOSFET in the auxiliary switch is off.

According to an embodiment, the fourth state is activated when all auxiliary switches in a phase arm of the first phase arm or the second phase arm have transitioned from the first state to the second state.

According to an embodiment, a converter circuit is provided, which includes a plurality of phase legs connected in parallel between two terminals of a voltage source. Each phase leg of the plurality of phase legs comprises a first phase arm comprising a plurality of switch devices and an inductor in a series connection; and a second phase arm comprising a plurality of switch devices and an inductor in a series connection. The first phase arm and the second phase arm are connected in series between the two terminals of the voltage source. An output terminal is connected to a point located between the first phase arm and the second phase arm. Each switch device of the plurality of switch devices in the first phase arm and the second phase arm comprises: a main switch with a first on-resistance; and an auxiliary switch with a second on-resistance, wherein the second on-resistance is greater than the first on-resistance.

According to an embodiment, a method for mitigating resonance, e.g., actively mitigating resonance, in a converter circuit is provided, which includes providing at least one phase leg circuit in the converter circuit. The phase leg circuit includes a first phase arm comprising a plurality of switch devices in a series connection, and a second phase arm comprising a plurality of switch devices in a series connection. The first phase arm and the second phase arm are connected in series between two terminals of a voltage source. A switching terminal is connected to a point located between the first phase arm and the second phase arm. Each switch device of the plurality of switch devices in the first phase arm and the second phase arm includes a main switch with a first on-resistance, and an auxiliary switch with a second on-resistance. The method also includes adjusting an on-state gate driving voltage to the auxiliary switches to adjust the second on-resistance of the auxiliary switches. The resulting second on-resistance is greater than the first on-resistance.

According to an embodiment, each auxiliary switch of the auxiliary switches in the plurality of switch devices of the first phase arm or the second phase arm comprises a junction field-effect transistor (JFET) and a MOSFET. The JFET is connected in anti-series with the MOSFET.

According to an embodiment, the method further includes controlling each auxiliary switch of the auxiliary switches in the plurality of switch devices of the first phase arm or the second phase arm to operate in four distinct states. The four states include a first state when the main switch is on, the JFET in the auxiliary switch is on, and the MOSFET in the auxiliary switch is off, a second state when the main switch is off, the JFET in the auxiliary switch is on, and the MOSFET in the auxiliary switch is on, thereby a capacitor is inserted into a circuit path comprising the auxiliary switch, a third state when the main switch is off, the JFET in the auxiliary switch is on, and the MOSFET in the auxiliary switch is off, where the capacitor in the circuit path comprising the auxiliary switch is pre-charged, and a fourth state when the main switch is off, the JFET in the auxiliary switch is off, and the MOSFET in the auxiliary switch is off.

According to an embodiment, the fourth state is activated when all auxiliary switches in a phase arm of the first phase arm or the second phase arm have transitioned from the first state to the second state.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE DRAWINGS

The present systems and methods for active resonance mitigation for quasi-two-level-based converter are described in detail below with reference to the attached drawing figures, wherein:

FIG. 1A illustrates a Quasi-two-level (Q2L) phase leg with two arms, according to one or more embodiments of the present disclosure.

FIG. 1B is a waveform diagram illustrating the voltage output over time at the AC terminal 106, according to one or more embodiments of the present disclosure.

FIG. 1C illustrates an example HBSM topology, according to one or more embodiments of the present disclosure.

FIG. 1D illustrates an example HBSM topology, according to one or more embodiments of the present disclosure.

FIG. 2A illustrates an example three-phase Q2L rectifier with three Q2L phase legs, according to one or more embodiments of the present disclosure.

FIGS. 2B and 2C illustrate the HBSM topologies and, respectively, with labeled voltages and currents, according to one or more embodiments of the present disclosure.

FIG. 3 shows simulation results for Case 1.

FIG. 4 shows simulation results for Case 2.

FIG. 5 shows a comparison between Case 2 and Case 3 simulations.

FIG. 6 shows output characteristics of a SiC MOSFET module.

FIG. 7A illustrates an example SM topology, according to one or more embodiments of the present disclosure.

FIG. 7B illustrates four switching states of a submodule implementing the SM topology, according to one or more embodiments of the present disclosure.

FIG. 8 illustrates an example SiC Cascaded Q2L (CQ2L) HVDC converter, according to one or more embodiments of the present disclosure.

FIG. 9 illustrates a method for actively mitigating resonance, according to one or more embodiments of the present disclosure.

### DESCRIPTION

The present disclosure provides systems and method for reducing LC resonance in Quasi-two-level (Q2L) circuits. In one or more embodiments, the LC resonance in Quasi-two-level (Q2L) circuits is reduced by active damping.

In one or more embodiments, a resonanceless Q2L converter phase leg is constituted using a plurality of half-bridge submodules (HBSMs). In at least one embodiment, the HBSMs utilize semicoductor switching devices, such as SiC MOSFETs or SiC Junction Field-Effect Transistors (JFETs). The Q2L converter phase leg can be used to construct high-control-bandwidth, fault-tolerant, power-dense, and cost-effective HVDC and MVDC converters to enhance transmission and distribution grid resilience, posing a disruptive techno-economic impact to not only power grid but broad cross-disciplinary areas, such as nuclear fusion systems.

In one or more embodiments, the submodules (SMs) implement an asymetric bidirectional auxillary switch. The auxillary switch includes a normally-on JFET and a MOSFET connected in anti-series. This bidirectional auxillary switch operates in four distinct states, including a bidirectional turn-off state, which can further reduce resonance.

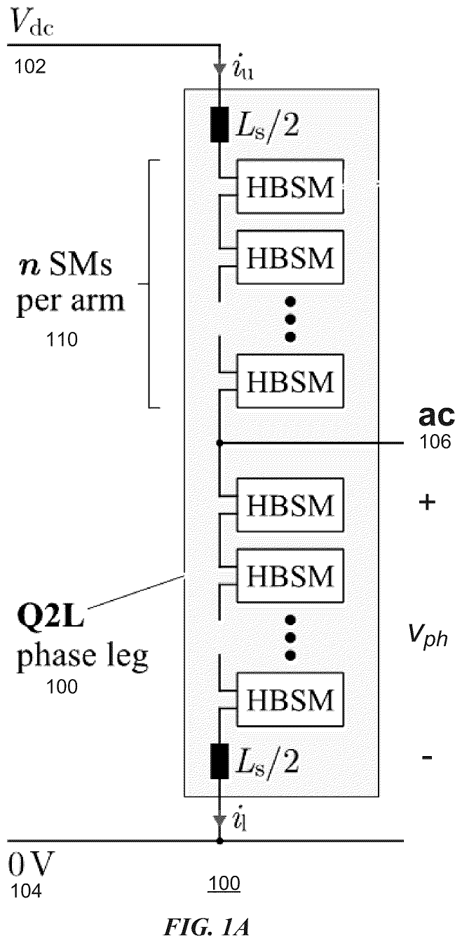

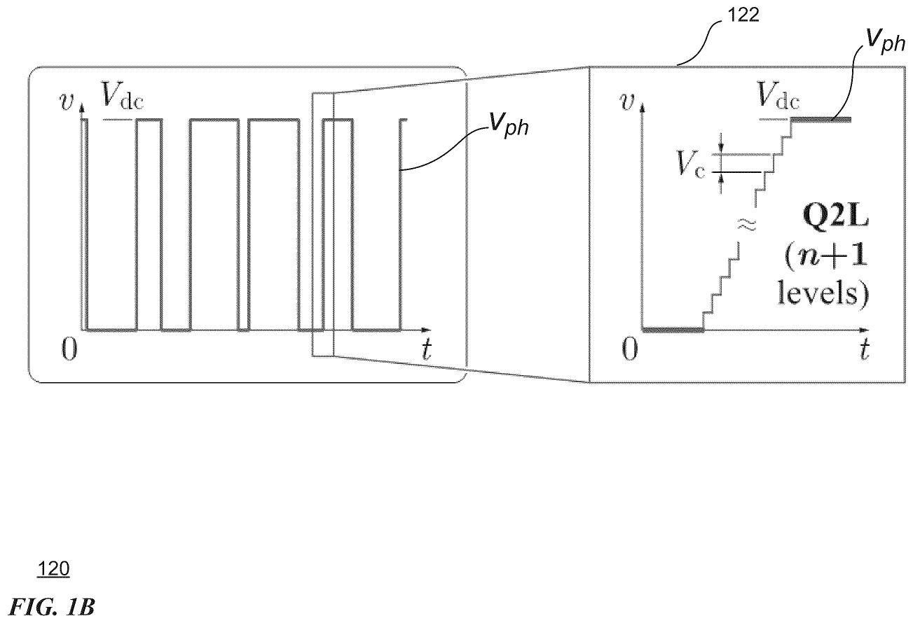

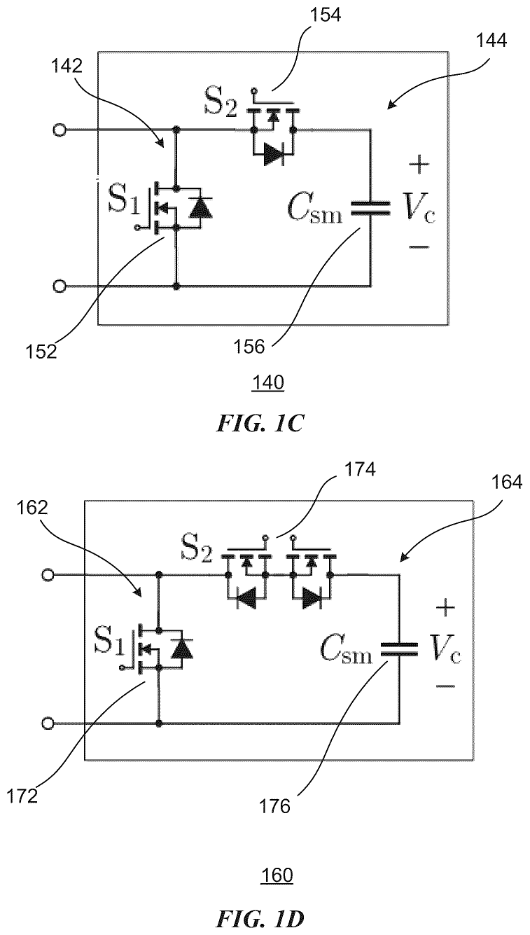

FIG. 1A illustrates a Quasi-two-level (Q2L) phase leg 100 with two arms 110, according to one or more embodiments of the present disclosure. The Q2L phase leg 100 is connected between a voltage source 102 and ground 104. For example, the voltage source 102 is a direct-voltage source, denoted as V_{dc}, the ground is denoted as “0V.” Each arm 110 includes a plurality of identical submodules (SMs) in series, along with a stray inductance (Lₛ/2). In at least one embodiment, the SMs are HBSMs. Examples HBSM topologies will be discussed hereafter, including FIGS. 1C and 1D. An alternating voltage (e.g., a phase voltage (Vₚₕ)) is output between an output terminal 106 (denoted as “ac”) and the ground 104.

As illustrated in FIG. 1A, the Q2L phase leg 100 includes an upper Q2L arm and a lower Q2L arm (e.g., the arms 110). Each Q2L arm consists of n number of series-connected HBSMs using semiconductor (e.g., Si or SiC) switch devices, along with non-negligible stray inductance (Lₛ) due to the large hardware geometry in practice. The Q2L arm produces a quasi-two-level arm voltage, which resembles the switch voltage in a two-level voltage source converter (2L-VSC) phase leg but includes many small staircases by slight control pulse delays between HBSMs. The small staircases turn the two-level into (n+1) levels in essence.

FIG. 1B is a waveform diagram 120 illustrating the voltage output over time at the AC terminal 106, according to one or more embodiments of the present disclosure. A zoomed-in view of a transition edge, representing a switching event between two voltage states (e.g., V_{dc} and zero volt), is shown in box 122. The ideal phase voltage (Vₚₕ), assuming Lₛ=0, exhibits a Q2L characteristic, which refers to the presence of (n+1) voltage levels during switching transients. These intermediate levels (e.g., V_{c}) help reduce the transition rate (e.g., dv/dt). In certain scenarios, wherein Lₛ≠0, resonance arises between the stray inductance (Lₛ) and the submodule capacitance (Cₛₘ), potentially leading to oscillations during switching transients.

FIG. 1C illustrates an example HBSM topology 140, according to one or more embodiments of the present disclosure. The HBSM topology 140 includes a primary path 142 and an auxiliary path 144, which are connected in parallel. The primary path includes a first switch (S₁) 152. The auxiliary path 144 includes a second switch (S₂) 154 and a submodule capacitor (Cₛₘ) 156. In the illustrated example, the second switch (S₂) 154 is a unidirectional auxiliary switch that works in the linear region (with high on-state resistance (Rₒₙ)) during on-state by a proper gate-driving voltage for unidirectional damping.

FIG. 1D illustrates an example HBSM topology 160, according to one or more embodiments of the present disclosure. The HBSM topology 160 includes a primary path 162 and an auxiliary path 164, which are connected in parallel. The primary path includes a first switch (S₁) 172. The auxiliary path 164 includes a second switch (S₂) 174 and a submodule capacitor (Cₛₘ) 176. In the illustrated example, the second switch (S₂) 174 is a bidirectional auxiliary switch that works in the linear region (with high on-state resistance (Rₒₙ)) during on-state by a proper gate-driving voltage for bidirectional damping.

The submodule (SM) capacitor voltage is given by V_{c}=V_{dc}/n, where V_{dc} is the DC bus voltage and n is the number of submodules per arm. To withstand the full DC bus voltage, the total number of inserted HBSMs (with S₁ turned on and S₂ turned off) in a Q2L arm should equal n. The dwell time of each voltage staircase is controlled to mitigate overvoltage caused by reflections at the AC terminal due to the high dv/dt of fast-switching semiconductor devices and the presence of long cables. This helps alleviate insulation voltage stress on inductors or transformers interfaced with the converter. In one example, the n SMs in the Q2L arm are configured to turn on at staggered timings, resulting in a switching transient composed of n+1 voltage steps.

As such, the Q2L arm voltage resembles a 2L characteristics but in effect breaks the two levels into n+1 levels by slight control pulse delays (e.g., 0.5 μs) between HBSMs. In this way, the transition (dv/dt) is confined to one HBSM instead of the full HVDC voltage to mitigate long-cable reflection overvoltage imposed on insulation of components interfaced with Q2L.

On the other hand, the Q2L arm current resembles the chopped currents of a 2L-VSC, but they are never physically cut off (which is the case of a 2L-VSC) because S₂ and SM capacitor Cₛₘ preserve the current conduction path. The current ratings of S₁ and S₂ in the SM are not identical. S₁ is the primary (or main) switch that conducts the most arm current, whereas S₂ is the auxiliary switch that conducts only during the dwell time of the Q2L staircases. Since the SM capacitor (Cₛₘ) conducts the opposite current to S₂, its root mean square (RMS) current and capacitance are quite low.

In the theoretical case where Lₛ=0, the Q2L phase voltage Vₚₕ shows ideal, clear staircases as depicted in FIG. 1B. However, in certain scenarios (e.g., HVDC converters), the SM number can be n>100, leading to Lₛ>5 μH. During the switching transients (staircases), LC resonance will occur between the two stray inductances

$$( 2 \times \frac{{L}_{s}}{2} )$$

and the inserted capacitance (i.e., Cₛₘ/n) in the DC loop. Consequently, huge arm current spikes and capacitor voltage fluctuation are induced.

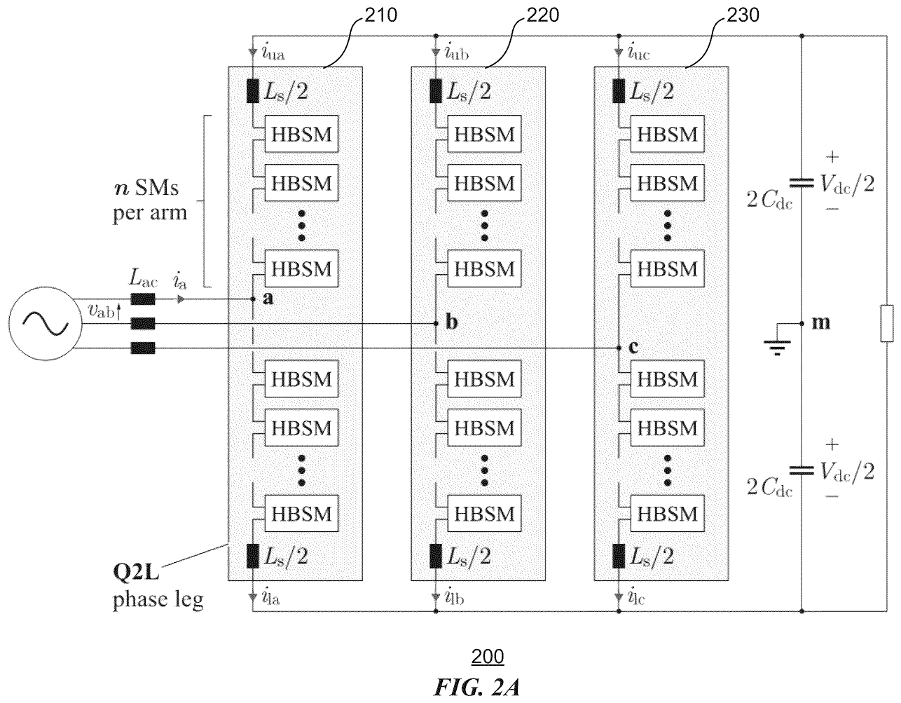

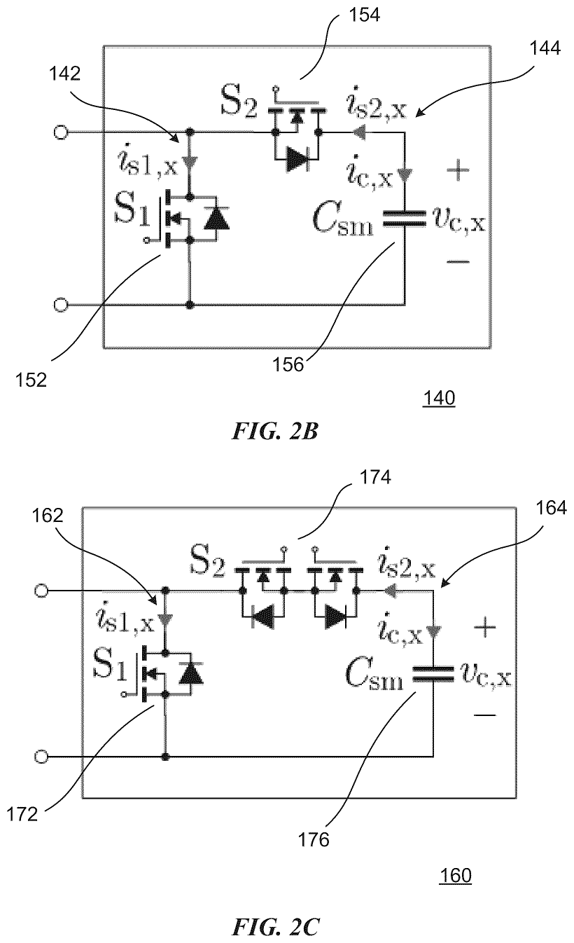

FIG. 2A illustrates an example three-phase Q2L rectifier 200 with three Q2L phase legs (210, 220, and 230), according to one or more embodiments of the present disclosure. The Q2L phase legs 210, 220, and 230 may employ the phase leg configurations disclosed herein, where each leg is connected between two voltages levels,

$$\frac{{V}_{dc}}{2} and - \frac{{V}_{dc}}{2} .$$

The current flowing through a lower arm is denoted as iᵤₐ, i_{ub}, or i_{uc}, while the current flowing through a lower arm is denoted as iₗₐ, i_{lb}, or i_{lc}. A load is connected to an output terminal tapped from a respective phase leg. This output terminal is situated between the upper and lower arms of the corresponding phase leg. For example, the load connected to phase leg 210 is denoted as L_{ac}, and the current flowing through the load is denoted as iₐ. A voltage difference between the outputs of different phase legs may be monitored, such as the voltage difference between phase legs 210 and 220, denoted as v_{ab}.

FIGS. 2B and 2C illustrate the HBSM topologies 140 and 160, respectively, with labeled voltages and currents, according to one or more embodiments of the present disclosure. The subscript “x” denotes one of u1, u2, u3, u4, or l1, l2, l3, or l4, where “u” represents upper arm and “l” represents lower arm. In an embodiment, a simulation model is established based on the three-phase Q2L rectifier 200 as depicted in FIG. 2A, utilizing HBSM topologies 140 and 160 shown in FIGS. 2B and 2C.

The simulation model sets V_{dc}=21 kV, n=4, Lₛ=10 μH, and Cₛₘ=60 μF. The AC line-to-line RMS V_{ab}=10 kV, Iₐ=187 A, f₀=400 Hz, and L_{ac}=15 mH. S₁ and S₂ are 10 kV SiC MOSFETs switching at f_{sw}=2 kHz. Three cases with different on-resistance of the devices are simulated:
Case 1: R_{s1,on}=R_{s2,on}=25 mΩ; S₂ is unidirectional.
Case 2: R_{s1,on}=25 mΩ and R_{s2,on}=500 mΩ; S₂ is unidirectional.
Case 3: R_{s1,on}=25 mΩ and R_{s2,on}=500 mΩ; S₂ is bidirectional.

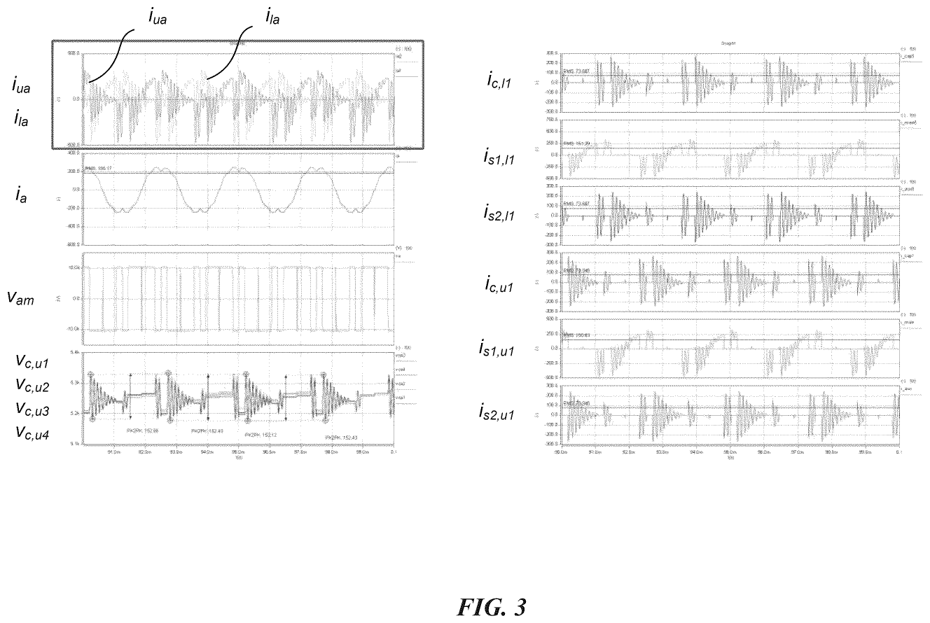

FIG. 3 shows simulation results for Case 1, which exhibit huge ringing on arm currents iᵤₐ and iₗₐ, and so as i_{c}, iₛ₁, and iₛ₂. Case 1 is the normal case without active damping. Huge ringing is observed in arm currents, device currents, and capacitor currents, resulting in significant increase in peak and RMS currents.

To address this issue, an active damping method is proposed, that is, the on resistance of S₂ is controlled to be much higher (e.g., R_{s2,on}=500 mΩ) to damp the LC resonance. Since S₂ is an auxiliary switch that only conducts during transition, increasing its on resistance will not add much power loss but provide effective damping.

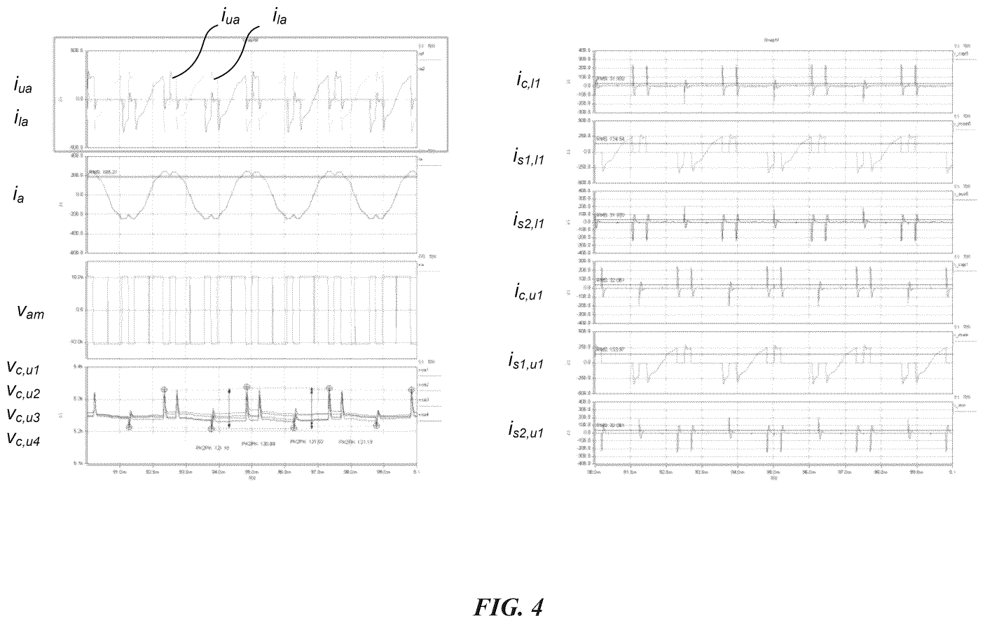

FIG. 4 shows simulation results for Case 2. The ringing on iᵤₐ, iₗₐ, i_{c}, iₛ₁, and iₛ₂ is successfully damped, but some spikes remain because the body diode of SiC MOSFETs is conducting when iₛ₂<0; R_{s2,on}=500 mΩ is ineffective.

As mentioned above, the Case 2 simulation result in FIG. 4 shows that all ringing is notably damped, and the arm currents iᵤₐ and iₗₐ become very similar to 2L-VSC. However, the current spikes still exist. This is because S₂ is a unidirectional switch with R_{s2,on}=500 mΩ only effective when iₛ₂>0. When iₛ₂<0, the S₂ current is flowing through its body (or anti-parallel) diode without damping effect.

In another embodiment, bidirectional S₂ is used, which may further address the spikes when iₛ₂<0. When using bidirectional S₂, R_{s2,on}=500 mΩ is effective for either current polarity.

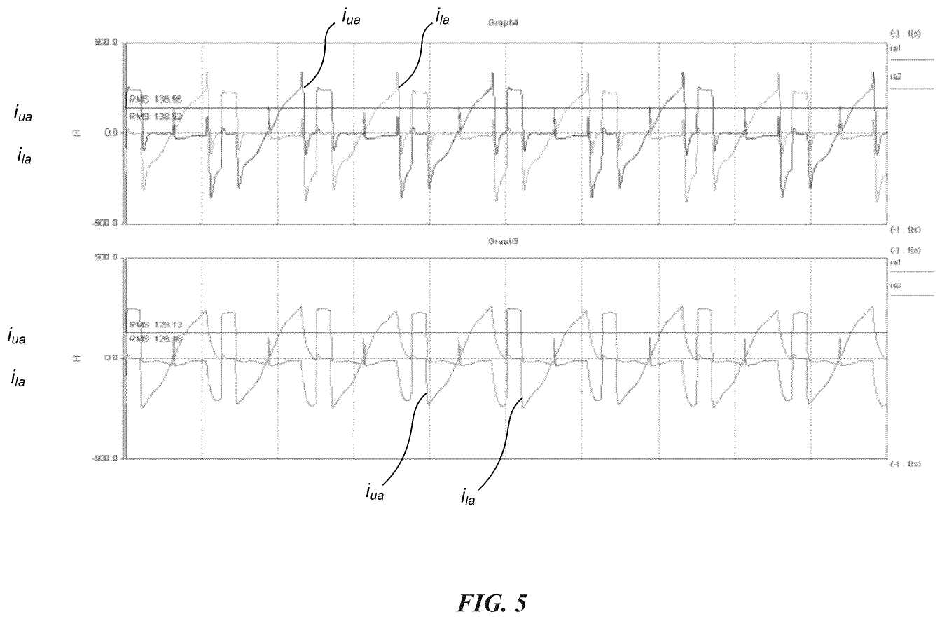

FIG. 5 shows a comparison between Case 2 and Case 3 simulations, which indicates that all ringing and spikes are suppressed by using bidirectional S₂. The bidirectional S₂ enables R_{s2,on}=500 mΩ and its damping for both iₛ₂<0 and iₛ₂>0. In some examples, R_{s2,on} may be designed lower to reduce its conduction loss while maintaining the good damping effect.

There are two approaches in general to realize a much higher R_{s2,on} than R_{s1,on} during conduction. One approach is to select a high on-resistance device for S₂ (typically with a smaller number of dies in the package), which is intuitive but might be subjected to loss limitation due to insufficient cooling area. The other approach is to design a proper on-state gate driving voltage (V_{gs}) for S₂. For power semiconductor devices, the equivalent on resistance is controlled by V_{gs} according to the output characteristics. The lower V_{gs} implemented, the higher on resistance will be. In an example, the on-state gate of the one or more auxiliary switches S₂ are actively controlled with variable voltage values and timings for different auxiliary switches S₂.

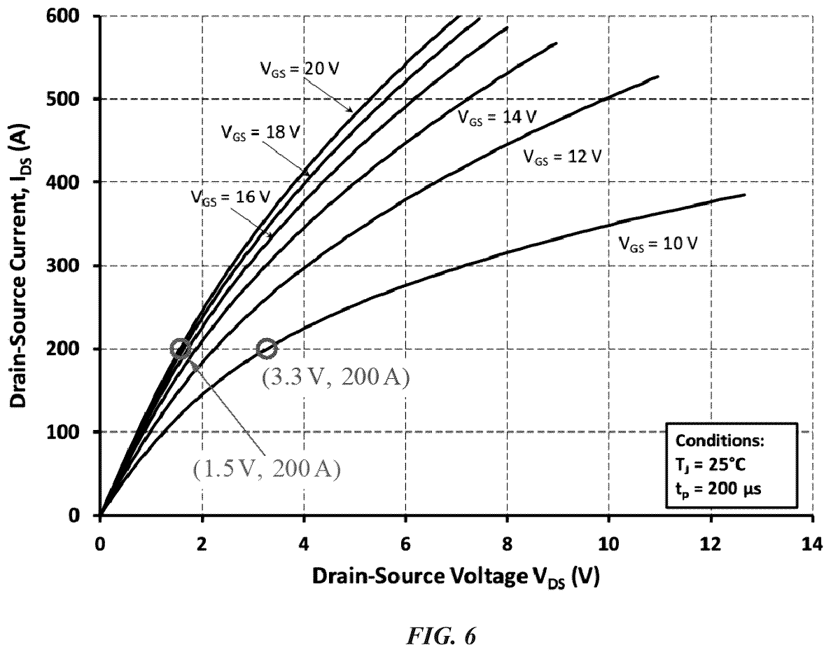

FIG. 6 shows output characteristics of a SiC MOSFET module. The SIC MOSFET module is rated at 1.7 kV, 225 A. As shown in FIG. 6, Rₒₙ=7.5 mΩ, when I_{d}=200 A and V_{gs}=20 V; Rₒₙ=16.5 mΩ, when I_{d}=200 A and V_{gs}=10 V.

The output characteristics in FIG. 6 shows that the module's on resistance can be increased by two times (or 2×) through reducing V_{gs}. Further reducing V_{gs} can achieve the goal. In one embodiment, the above-discussed two approaches may be combined to achieve an optimal design, which may address the concern of under-utilization and wasting of the device's die area.

The bidirectional auxiliary switch (e.g., S₂) in SM may be implemented using various types of devices. In one embodiment, the bidirectional switch includes two metal-oxide-semiconductor field-effect transistors (MOSFETs) connected in a back-to-back (or anti-series) configuration. In another embodiment, the bidirectional switch includes a junction field-effect transistor (JFET) and a MOSFET. It will be noted that other types of devices, such as insulated-gate bipolar transistors (IGBTs), bipolar junction transistor (BJTs), insulated-gate-commutated Thyristor (IGCT), silicon carbide (SiC) transistors, and gallium nitride (GaN) transistors, and more.

In some embodiments, the switch devices may be made of silicon, wide bandgap (WBG) materials (e.g., SiC, GaN, AlGaN, etc.), or any other suitable semiconductor materials.

The active damping methods and devices can be employed in various Q2L-based converters for a wide range of AC or DC applications, such as Q2L buck converters, Q2L dual active bridges, Q2L solid-state transformers, cascaded Q2L converters, etc.

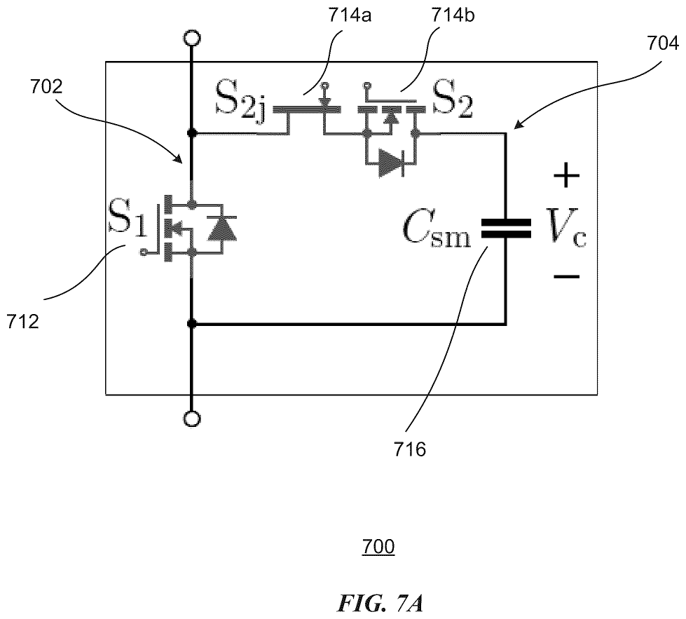

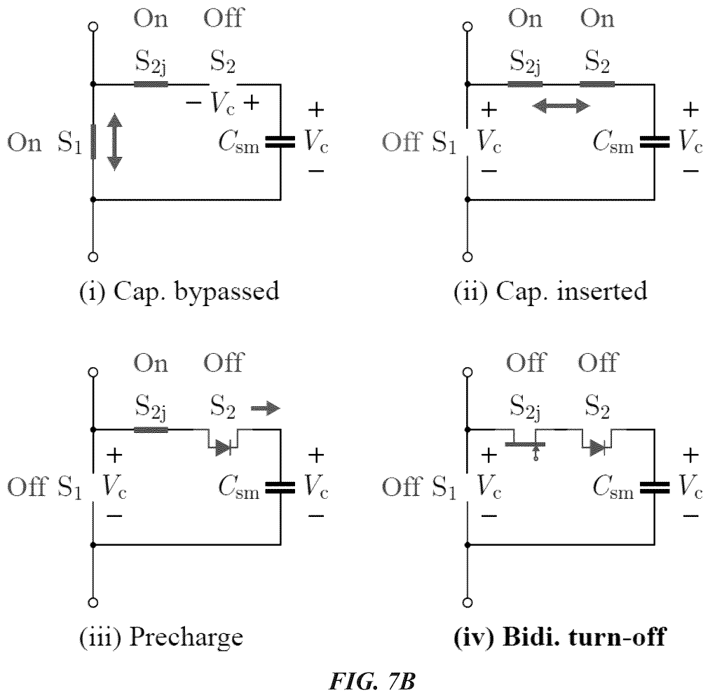

FIG. 7A illustrates an example SM topology 700, according to one or more embodiments of the present disclosure. The SM topology 700 implements an asymmetrical bidirectional configuration as the auxiliary switch.

Q2L may exhibit a phase-leg resonance between Lₛ and Cₛₘ/n, when S₂ and Cₛₘ preserve current continuity while S₁ is off. This issue can be mitigated by adding a resistor in series with Cₛₘ at the cost of power losses and an efficiency drop. The SM topology 700 provides a lossless solution to this challenge, specifically by cutting off the resonance loop upon the completion of commutation.

As shown in FIG. 7A, the SM topology 700 includes a primary path 702 and an auxiliary path 704, which are connected in parallel. The primary path 702 includes a first switch (S₁) 712. The auxiliary path 704 includes a third switch (S₂ⱼ) 714a, a second switch (S₂) 714b, and a submodule capacitor (Cₛₘ) 716. In at least one embodiment, the first switch (S₁) 712 is a normally-off SiC MOSFET, the third switch (S₂ⱼ) 714a is a normally-on SiC Junction Field-Effect Transistor (JFET), and the second switch (S₂) 714b is a normally-off SiC MOSFET. The third switch (S₂ⱼ) 714a is connected in anti-series with the second switch (S₂) 714b, and together they function as a bidirectional switching device.

FIG. 7B illustrates four switching states of a submodule implementing the SM topology 700, according to one or more embodiments of the present disclosure. The four switching states include: (i) a first state when the capacitor (Cₛₘ) is bypassed; (ii) a second state when the capacitor (Cₛₘ) is inserted; (iii) a third state of precharging; and (iv) a fourth state when the bidirectional switching device is turned off. FIG. 7B emphasizes the effect of each component in different states (i.e. with different components on/off).

As shown in FIG. 7B, in the first state, the first switch (S₁) 712 is on, thereby bypassing the capacitor (Cₛₘ).

In the second state, the first switch (S₁) 712 is off, the bidirectional switching device (including S₂ⱼ 714a and S₂ 714b) is on, the capacitor (Cₛₘ) 716 is inserted into the circuit. In this state, the current is bidirectional.

In the third state, S₁ 712 is off, S₂ⱼ 714a is on, and S₂ 714b is off. In this state, the capacitor (Cₛₘ) is precharging.

In the fourth state, S₁ 712 is off, S₂ⱼ 714a is off, and S₂ 714b is off. This state is also referred to as a bidirectional turn-off state. The bidirectional turn-off state enables the SM to operate without resonance. Q2L configured with a bidirectional turn-off state is also referred to as rQ2L. Bidirectional turn-off is realized by the anti-series of the off-state JFET (e.g., S₂ⱼ 714a) and the reverse-biased MOSFET body diode (e.g., S₂ 714b). The bidirectional turn-off state is activated after all SMs in an arm of an Q2L (or rQ2L) phase leg have transitioned (one after another in the Q2L way) from the first state to the second state. The SM topology 700 in the bidirectional turn-off state resembles a turned-off MOSFET that stops bidirectional current flow when blocking a forward voltage. Hence, an rQ2L phase leg is the same as a 2L (with series devices) phase leg in static state, and the same as a Q2L phase leg in dynamic transition. Also, an advantage is in that S₂ⱼ is at an auxiliary current rating and in theory should take zero voltage when it is turned off, so a low-voltage, low-current SiC JFET serves the purpose and adds negligible costs to the system.

The JFET (e.g., the third switch (S₂ⱼ) 714a) is a normally-on component, so it doesn't require any power to be switched ON in any of the first, second, and third states, which is important for the “pre-charge” state, since the normally-on JFET does not negatively impact the circuit. The “active resonance mitigation” comes from the fact that in the fourth state, the JFET can be switched OFF, blocking current that would normally flow via the MOSFET flyback diode (as indicated by the arrow in the third state).

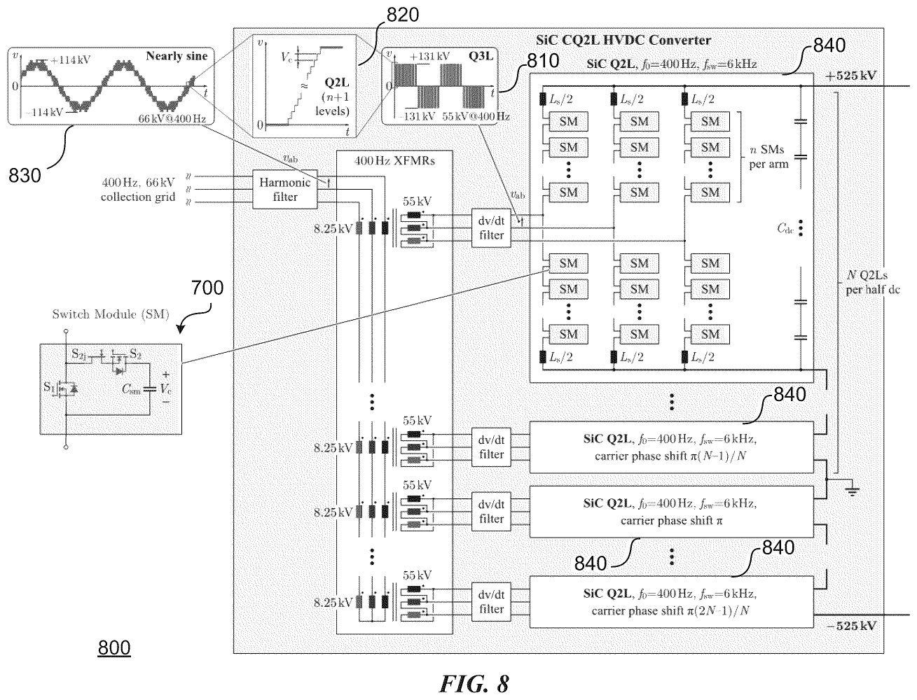

FIG. 8 illustrates an example SiC Cascaded Q2L (CQ2L) HVDC converter 800, according to one or more embodiments of the present disclosure. The converter 800 includes a plurality of SiC Q2L phase legs, each integrated into one of the three-phase Q2L devices 840 (e.g., the three-phase Q2L rectifier 200 shown in FIG. 2A). Each SiC Q2L phase leg within a three-phase Q2L device 840 includes a plurality of SMs arranged in a manner similar to the phase leg illustrated in FIG. 1A or FIG. 2A. The SMs may adopt the SM topology 700, as shown in FIG. 7A.

As shown in FIG. 8, the auxiliary path in the SM includes a junction field-effect transistor (JFET) and a MOSFET. The JFET (e.g., S₂ⱼ) may be an always-on JFET. This bidirectional JFET-MOSFET (“asymmetrical”) switch may be used to damp resonance in a Q2L (or CQ2L) converter. As such, the SMs in the converter 800 may operate in the four states as illustrated in FIG. 7B. This design may provide various benefits, including decreased complexity of control electronics, reduced resonance (instability) in the resulting circuit, limiting large current or voltage spikes which can damage insulation or other hardware, and more.

The waveform in box 810 shows the voltage output between two phase legs in a three-phase Q2L device 840. The waveform in box 820 illustrates voltage staircases occurring during switching transients in the waveforms shown in box 810 or box 830. The waveform in box 830 also indicates the voltage output from the phase legs.

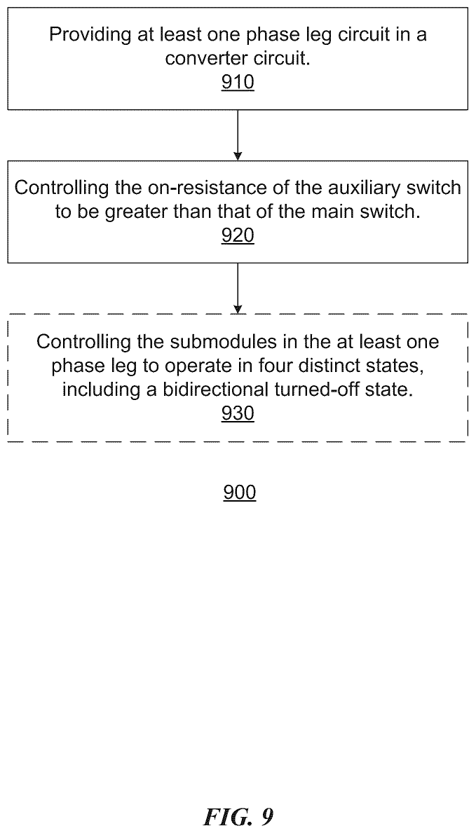

FIG. 9 illustrates a method 900 for actively mitigating resonance, according to one or more embodiments of the present disclosure. Method 900 may be performed alone or in combination with other processes in the present disclosure. It will be recognized that method 900 may be performed in any suitable environment and in any suitable order except where otherwise apparent. Alternative stages may be performed instead of or in addition to those shown, and some stages may be omitted entirely. In the illustrated example, active resonance mitigation is described in the context of a converter circuit. However, it should be noted that the method can also be implemented in other suitable circuits to achieve active resonance mitigation.

At stage 910, at least one phase leg circuit is provided within a converter circuit. For example, Q2L (or rQ2L) phase legs disclosed herein—including those shown in FIGS. 1A, 2A, and 8—may be implemented, along with any of the disclosed SM topologies, such as those illustrated in FIGS. 1C, 1D, or 7A. In at least one embodiment, a plurality of Q2L phase legs are connected to form a CQ2L HVDC converter, as shown in FIG. 8.

At stage 920, the on-resistance of the auxiliary switch is controlled to be greater than that of the main switch. The auxiliary switch is configured to have a higher on-resistance than the main switch. In at least one embodiment, this is achieved through design and fabrication choices that ensure the auxiliary switches exhibit greater on-resistance than the main switch. In at least one embodiment, the auxiliary switches are controlled by an on-state gate driving voltage, which is determined based on the output characteristics of the Q2L phase leg circuit.

In at least one embodiment, each auxiliary switch includes JFET and a MOSFET, connected in anti-series. For example, the SMs in the phase legs implement the topology 700 as shown in FIG. 7A. Accordingly, the SMs can operate in four distinct states as shown in FIG. 7B. As such, at stage 930, the SMs in the at least one phase leg are controlled to operate in the four distinct states. For example, the bidirectional turn-off state (e.g., the fourth state) enables further mitigation of resonance. In at least one embodiment, the fourth state is activated when all auxiliary switches in a phase arm of the first phase arm or the second phase arm have transitioned from the first state to the second state.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the disclosed subject matter (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or example language (e.g., “such as”) provided herein, is intended merely to better illuminate the disclosed subject matter and does not pose a limitation on the scope of the invention unless otherwise claimed. No language in the specification should be construed as indicating any non-claimed element as essential to the practice of the invention.

Certain embodiments are described herein. Variations of those embodiments may become apparent to those of ordinary skill in the art upon reading the foregoing description. The inventors expect skilled artisans to employ such variations as appropriate, and the inventors intend for the embodiments to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A quasi-two-level (Q2L) phase leg circuit, comprising:
a first phase arm comprising a plurality of switch devices in a series connection; and
a second phase arm comprising a plurality of switch devices in a series connection,
wherein the first phase arm and the second phase arm are connected in series between two terminals of a voltage source,
wherein a switching terminal is connected to a point located between the first phase arm and the second phase arm, and
wherein each switch device of the plurality of switch devices in the first phase arm and the second phase arm comprises:
a main switch with a first on-resistance; and
an auxiliary switch with a second on-resistance, wherein the second on-resistance is greater than the first on-resistance.

2. The circuit according to claim 1, wherein each switch device of the plurality of switch devices in the first phase arm and the second phase arm comprises a capacitor,
wherein in the respective switch device of the plurality of switch devices in the first phase arm and the second phase arm, the corresponding capacitor and auxiliary switch are connected in series, and the corresponding main switch is connected in parallel.

3. The circuit according to claim 1, wherein the plurality of switch devices of at least one of the first phase arm and the second phase arm includes n switch devices, wherein n is an integer greater than one,
wherein the n switch devices in the respective phase arm are configured to turn on at different timings, resulting in a switch transient that comprises n+1 voltage staircases.

4. The circuit according to claim 1, wherein the plurality of switch devices of the first phase arm or the second phase arm comprise one or more half-bridge submodules (HBSMs).

5. The circuit according to claim 1, wherein the plurality of switch devices of the first phase arm or the second phase arm comprise at least one of Insulated Gate Bipolar Transistor (IGBT), Integrated Gate-Commutated Thyristor (IGCT), Metal-Oxide-Semiconductor Field-Effect Transistor (MOSFET), or Junction Field-Effect Transistor (JFET).

6. The circuit according to claim 1, wherein the plurality of switch devices of the first phase arm or the second phase arm are made of silicon or wide bandgap (WBG) materials.

7. The circuit according to claim 1, wherein the auxiliary switches in the plurality of switch devices of the first phase arm or the second phase arm are unidirectional.

8. The circuit according to claim 1, wherein one or more auxiliary switches in the plurality of switch devices of the first phase arm or the second phase arm operate in a partially-on state during a switch transient.

9. The circuit according to claim 8, wherein the one or more auxiliary switches are controlled by an on-state gate driving voltage for the one or more auxiliary switches, and wherein the on-state gate driving voltage is determined based on output characteristics of the Q2L phase leg circuit.

10. The circuit according to claim 9, wherein the on-state gate of the one or more auxiliary switches are actively controlled with variable voltage values and timings for different auxiliary switches.

11. The circuit according to claim 1, wherein the auxiliary switches in the plurality of switch devices of the first phase arm or the second phase arm are bidirectional.

12. The circuit according to claim 11, wherein each auxiliary switch of the auxiliary switches in the plurality of switch devices of the first phase arm or the second phase arm comprises a pair of metal-oxide-semiconductor field-effect transistors (MOSFETs) in a back-to-back configuration.

13. The circuit according to claim 11, wherein each auxiliary switch of the auxiliary switches in the plurality of switch devices of the first phase arm or the second phase arm comprises a junction field-effect transistor (JFET) and a MOSFET, and wherein the JFET is connected in anti-series with the MOSFET.

14. The circuit according to claim 13, wherein each auxiliary switch of the auxiliary switches in the plurality of switch devices of the first phase arm or the second phase arm operates in four distinct states, comprising:
a first state when the main switch is on, the JFET in the auxiliary switch is on, and the MOSFET in the auxiliary switch is off;
a second state when the main switch is off, the JFET in the auxiliary switch is on, and the MOSFET in the auxiliary switch is on, thereby a capacitor is inserted into a circuit path comprising the auxiliary switch;
a third state when the main switch is off, the JFET in the auxiliary switch is on, and the MOSFET in the auxiliary switch is off, wherein the capacitor in the circuit path comprising the auxiliary switch is precharged; and
a fourth state when the main switch is off, the JFET in the auxiliary switch is off, and the MOSFET in the auxiliary switch is off.

15. The circuit according to claim 14, wherein the fourth state is activated when all auxiliary switches in a phase arm of the first phase arm or the second phase arm have transitioned from the first state to the second state.

16. A converter circuit, comprising
a plurality of phase legs connected in parallel between two terminals of a voltage source,
wherein each phase leg of the plurality of phase legs comprises:
a first phase arm comprising a plurality of switch devices and an inductor in a series connection; and
a second phase arm comprising a plurality of switch devices and an inductor in a series connection,
wherein the first phase arm and the second phase arm are connected in series between the two terminals of the voltage source,
wherein an output terminal is connected to a point located between the first phase arm and the second phase arm, and
wherein each switch device of the plurality of switch devices in the first phase arm and the second phase arm comprises:
a main switch with a first on-resistance; and
an auxiliary switch with a second on-resistance, wherein the second on-resistance is greater than the first on-resistance.

17. A method for mitigating resonance in a converter circuit, comprising:
providing at least one phase leg circuit in the converter circuit, wherein the phase leg circuit comprises:
a first phase arm comprising a plurality of switch devices in a series connection; and
a second phase arm comprising a plurality of switch devices in a series connection,
wherein the first phase arm and the second phase arm are connected in series between two terminals of a voltage source,
wherein a switching terminal is connected to a point located between the first phase arm and the second phase arm, and
wherein each switch device of the plurality of switch devices in the first phase arm and the second phase arm comprises:
a main switch with a first on-resistance; and
an auxiliary switch with a second on-resistance;
adjusting an on-state gate driving voltage to the auxiliary switches to adjust the second on-resistance of the auxiliary switches, wherein the resulting second on-resistance is greater than the first on-resistance.

18. The method according to claim 17, wherein each auxiliary switch of the auxiliary switches in the plurality of switch devices of the first phase arm or the second phase arm comprises a junction field-effect transistor (JFET) and a MOSFET, and wherein the JFET is connected in anti-series with the MOSFET.

19. The method according to claim 18, further comprising:
controlling each auxiliary switch of the auxiliary switches in the plurality of switch devices of the first phase arm or the second phase arm to operate in four distinct states, wherein the four states comprises:
a first state when the main switch is on, the JFET in the auxiliary switch is on, and the MOSFET in the auxiliary switch is off;
a second state when the main switch is off, the JFET in the auxiliary switch is on, and the MOSFET in the auxiliary switch is on, thereby a capacitor is inserted into a circuit path comprising the auxiliary switch;
a third state when the main switch is off, the JFET in the auxiliary switch is on, and the MOSFET in the auxiliary switch is off, wherein the capacitor in the circuit path comprising the auxiliary switch is precharged; and
a fourth state when the main switch is off, the JFET in the auxiliary switch is off, and the MOSFET in the auxiliary switch is off.

20. The method according to claim 19, wherein the fourth state is activated when all auxiliary switches in a phase arm of the first phase arm or the second phase arm have transitioned from the first state to the second state.
